(19) United States
(12) Patent Application Publication
(10) Pub. No.: US 2002/0142804 A1
(43) Pub. Date: Oct. 3, 2002

(54) Printer, printing system, printing method and computer-readable program

(76) Inventor: Hideki Morozumi, Nagano-Ken (JP)

Correspondence Address: MATTINGLY, STANGER & MALUR, P.C., ATTORNEYS AT LAW, SUITE 370, 1800 DIAGONAL ROAD, ALEXANDRIA, VA, 22314, US

(21) Appl. No.: 10/106,229

(22) Filed: Mar. 27, 2002

(30) Foreign Application Priority Data
Mar. 28, 2001 (JP) 2001-093240
Feb. 4, 2002 (JP) 2002-27183

(51) Int. Cl. H04M 1/00

(52) U.S. Cl. 455/557; 455/550

(57) ABSTRACT

A simplified procedure for preparing a printed matter having a fixed format. A printer 10 makes a radio terminal 25 display an input item reception screen according to form data stored in an input item reception form storing means 32. Input items are received from the radio terminal 25 through the above-mentioned screen. According to a print condition stored in a print condition storing unit 38, these input items are overlaid on a print form, which is stored in a print form storing unit 31, and printed.

### BACKGROUND OF THE INVENTION

The present invention relates to a technique suitable for printing a printed matter having a fixed format.

2. Related Art Statement

Usually, a printer is considered as a peripheral device for a PC or the like, and, in use, generally connected with a computer. In that case, the computer functions as a printer host. For example, when a computer operator generates information, using an application program that runs on the computer, then, the computer converts the information into a print control signal, according to instructions from the application program, and sends the signal to the printer.

### SUMMARY OF THE INVENTION

When such a conventional printing system comprising a computer and a printer is used for a procedure of issuing a printed matter having a fixed format such as a membership card or an order slip, following problems may arise.

Usually, a clerk (a reception clerk (at the window)) hands a specific form to a user so that the user enters private information (name, address, etc.), which is required for issuing a membership card, into the form. Then, the clerk receives the form from the user, and inputs the private information entered in the form and other required information such as a member's number etc. into a computer functioning as a printer host, through a keyboard. In other words, it requires for the clerk, labor of preparing the form and labor of inputting the information entered in the form into the computer.

The present invention has been made considering the above situations into consideration. And, an object of the invention is to simplify a procedure of printing a printed matter having a fixed format.

To solve the above problem, in the present invention, form data for an input item reception screen are transmitted to a radio terminal, to make the radio terminal display the input item reception screen. Input items are received from a user of the radio terminal through the input item reception screen. Next, the input items received from the user of the radio terminal are composite with print form data, to print the composite data.

In the case where the present invention is used for a procedure of issuing a printed matter having a fixed format such as a membership card, an order slip, or the like, it is possible to issue the printed matter only by simple user operation. Namely, a user of a radio terminal owned by him or lent from the side of the issuing procedure uses the radio terminal to input required information according to contents displayed on the radio terminal and to transmit the inputted information, to issue the printed matter. Thus, labor on the issuing side can be reduced.

### BRIEF DESCRIPTION OF THE DRAWINGS

FIG. 1 is a schematic block diagram showing a printer to which a first embodiment of the present invention is applied;

FIG. 2 is a functional block diagram showing the printer of FIG. 1;

FIG. 3A to FIG. 3C are views showing an example of an input item reception screen that is displayed on a radio terminal 25 according to input item reception form data stored in an input item reception form storing unit 32 shown in FIG. 2;

FIG. 4 is a view showing an example of a print form given by print form data stored in a print form storing unit 31 shown in FIG. 2;

FIG. 5 is a flowchart for explaining operation of a printer to which the first embodiment of the present invention is applied;

FIG. 6 is a view for explaining an example of a printed matter outputted from a printer to which the first embodiment of the present invention is applied;

FIG. 7 is a view showing an example of a printed matter selection screen displayed on the radio terminal 25 according to form data stored in the input item reception form storing unit 32 shown in FIG. 2;

FIG. 8 is a view showing an example of the input item reception screen that is displayed on the radio terminal 25 according to the input item reception form data stored in the input item reception form storing unit 32 shown in FIG. 2;

FIG. 9 is a view showing an example of an input item confirmation screen displayed on the radio terminal 25;

FIG. 10 is a schematic block diagram showing a printing system to which a second embodiment of the present invention is applied;

FIG. 11 is a functional block diagram showing a printer host 50 shown in FIG. 10;

FIG. 12A to FIG. 12F are views showing an example of an input item reception screen that is displayed on the radio terminal 25 according to CD order slip form data stored in the input item reception form storing unit 32 shown in FIG. 11;

FIG. 13A to FIG. 13B are views showing an example of an input item reception screen that is displayed on the radio terminal 25 according to words card form data stored in the input item reception form storing unit 32 shown in FIG. 11;

FIG. 14 is an example of a print form given by print form data stored in the print form storing unit 31 shown in FIG. 11;

FIG. 15 is a flowchart for explaining operation of a printer host to which the second embodiment of the present invention is applied;

FIG. 16 is a view for explaining an example of a printed matter outputted from a print system to which the second embodiment of the present invention is applied;

FIG. 17 is a functional block diagram showing a print system of a third embodiment of the present invention;

FIG. 18 is a flowchart for explaining operation of an input item reception server shown in FIG. 17;

FIG. 19 is a flowchart for explaining operation of a printer shown in FIG. 17; and

FIG. 20 is a diagram for explaining a variant in which an input item reception server and a printer in the third embodiment of the present invention are integrated.

### DETAILED DESCRIPTION OF THE PREFERRED EMBODIMENTS

Now, embodiments of the present invention will be described.

To begin with, a first embodiment of the present invention will be described.

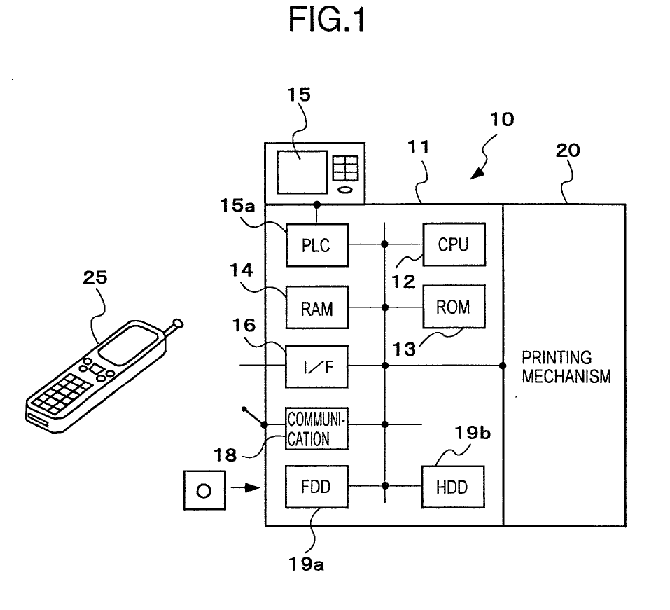

FIG. 1 shows a schematic configuration of a printer to which the first embodiment of the present invention is applied.

The printer 10 of the present embodiment receives input items as information required for printing, from a user of a radio terminal 25 through a radio interface; generates an image that is obtained by locating each of the received input items at a predetermined position on print form data (for example, form overlay data) previously registered in the printer; and prints the generated image.

As shown in the figure, the printer 10 of the present embodiment comprises a printing mechanism 20 and a print control unit 11.

The print control unit 11 comprises: a CPU 12 for executing various programs; a ROM 13 storing data and programs; a RAM 14 functioning as a work area for the CPU 12; a console panel 15 provided with a monitor; a panel controller (PLC) 15a controlling the console panel 15; a radio communication circuit 18 for communicating with the radio terminal 25 utilizing, for example, Bluetooth, infrared communication, or a wireless LAN of IEEE802.11b; an interface (I/F) circuit 16 for communicating with a network device through a wired LAN; and external storage such as a floppy (a registered trademark) disk drive (FDD) 19a and a hard disk drive (HDD) 19b.

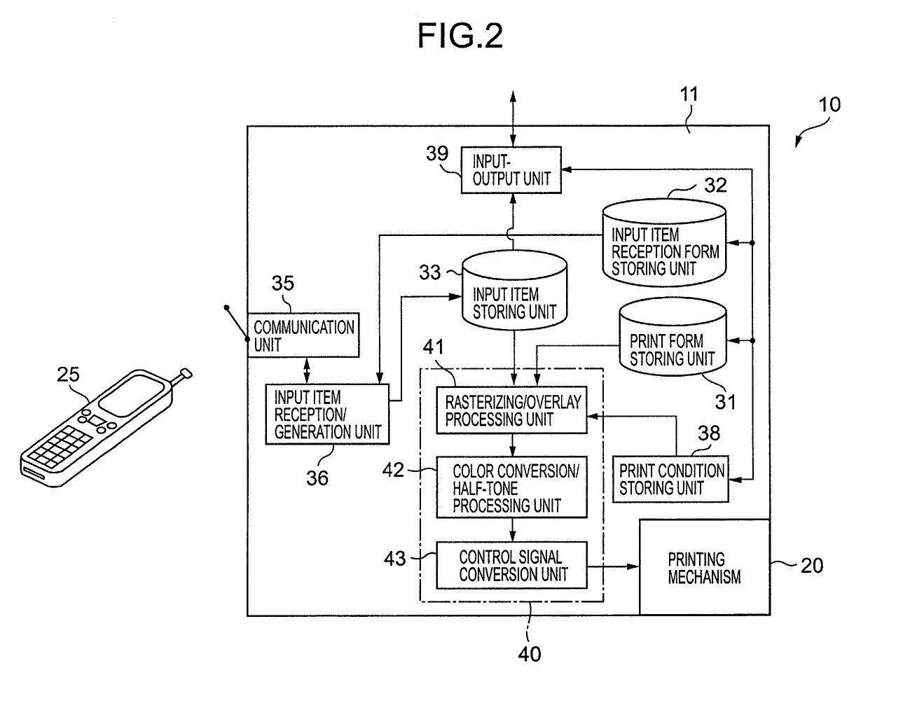

FIG. 2 is a functional block diagram of the printer 10 shown in FIG. 1.

These functional blocks are implemented by the CPU 12 executing programs stored in the ROM 13 etc.

A communication unit 35 communicates with the radio terminal 25 by radio communication.

An input item reception form storing unit 32 stores input item reception form data in order to make the radio terminal 25 display an input terminal reception screen. The input item reception form data is prepared by utilizing XML (eXtensible Markup Language), CGI (Common Gateway Interface), Java (a registered trademark) or the like. In the present embodiment, an HTML (Hyper Text Markup Language) file and CGI programs are used.

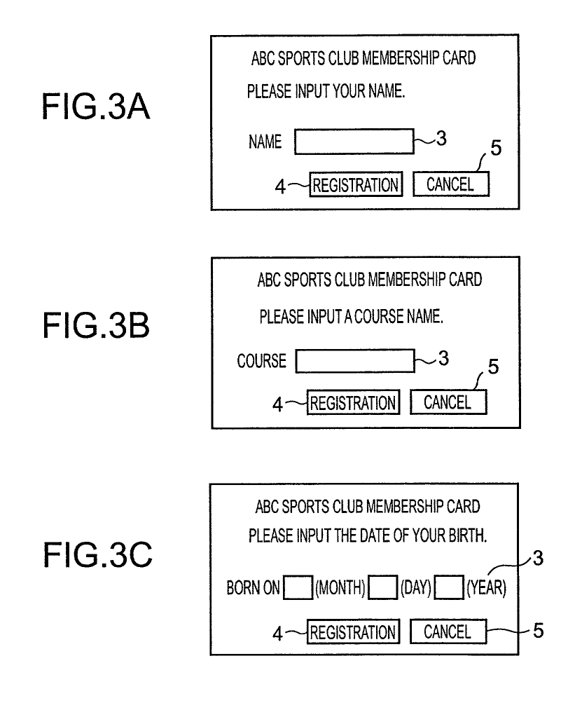

FIG. 3A to FIG. 3C show an example of the input item reception screen that is displayed on the radio terminal 25 according to input item reception form data. Here, input items for specifying private information required for printing a “ABC sports club membership card” are received through respective separate screens. In each screen, an input column 3 is displayed together with an explanation of the input item. A user of the radio terminal 25 can input information into an input column 3 by key operation. Here, a reference numeral 4 refers to a registration button. When a registration button 4 is selected for example by key operation, then, information inputted in an input column 3 is transmitted from the radio terminal 25 to the printer 10. Further, a reference numeral 5 refers to a cancel button. When a cancel button 5 is selected for example by key operation, then, information inputted in an input column 3 is cleared.

A print form storing unit 31 stores the print form data (form overlay data) that is printed being overlaid with the input items.

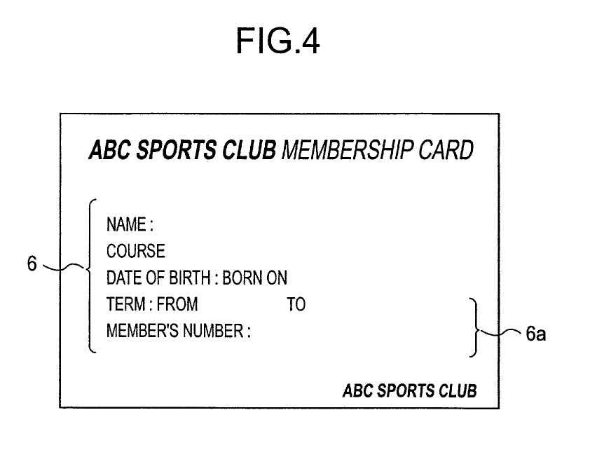

FIG. 4 shows an example of a print form. Here, is shown a print form that is printed being overlaid with the input items received from the radio terminal 25 through the input item reception screen shown in FIG. 3. The reference numeral 6 refers to explanation of the input items that specify private information to be printed on a “ABC sports club membership card”, and the input items are overlaid at respective corresponding positions in the explanation.

Here, in the present embodiment, input items to be overlaid at positions corresponding to explanation 6a of a membership period and member's number are automatically generated by the printer 10. In the following, the input items received from the user of the radio terminal 25 are called user input items, and the input items automatically generated by the printer 10 are called given input items. Further, taken together, the user input items and the given input items are simply called the input items.

The print form data stored in the print form storing unit 31 may take the form of RGB data or the form of intermediate code (a set of draw commands).

An input item storing unit 33 stores input items.

A print condition storing unit 38 stores print condition data (a font type, font size, font color, positions on a print form, etc. of the input items) as conditions for overlaying the input items on the print form data.

An input-output unit 39 inputs and outputs the input item reception form data, the print form data and the print condition data through a storage medium such as an FD, a communication medium such as a network, or the console panel 15.

An input item reception/generation unit 36 reads the input item reception form data from the input item reception form storing unit 32, and transmits the form data to the radio terminal 25 that has accessed the printer 10, through the communication unit 35. This makes the radio terminal 25 display the input terminal reception screen, to receive the user input items from the user of the radio terminal 25. Further, the given input items, which are to be overlaid together with the received user input items on the print form, are automatically generated if necessary. These input items are stored into the input item storing unit 33.

A control signal generation unit 40 generates a control signal that is to be outputted to the printing mechanism 20, based on the input items stored in the input item storing unit 33, the print form data stored in the print form storing unit 31 and the print condition data stored in the print condition storing unit 38. The control signal generation unit 40 comprises a rasterizing/overlay processing unit 41, a color conversion/half-tone processing unit 42, and a control signal conversion unit 43.

The rasterizing/overlay processing unit 41 creates an image of each input item on the print form, according to the print condition data. By this, each input item is overlaid on the print form. At this time, when the print form data stored in the print form storing unit 31 takes the form of intermediate code, then, the print form is drawn according to this intermediate code, and the print form is converted into RGB data before each input item is rasterized over the print form.

The color conversion/half-tone processing unit 42 performs color conversion processing on the RGB image data outputted from the rasterizing/overlay processing unit 37, to convert the data into CMYK image data. Further, the color conversion/half-tone processing unit 42 performs half-tone processing on the CMYK image data.

And, the control signal conversion unit 43 converts the CMYK image data, which have been subjected to the half-tone processing, into a control signal of the printing mechanism 20.

In the above operation, the communication unit 35 is implemented by the CPU 12 controlling the radio communication circuit 18. As each storing unit 31 to 33 and the print condition storing unit 38, the external storage such as the FDD 19a or HDD 19b is used. Further, the input-output unit 39 is implemented by the CPU 12 controlling the FDD 19a, I/F circuit 16, and PLC 15a.

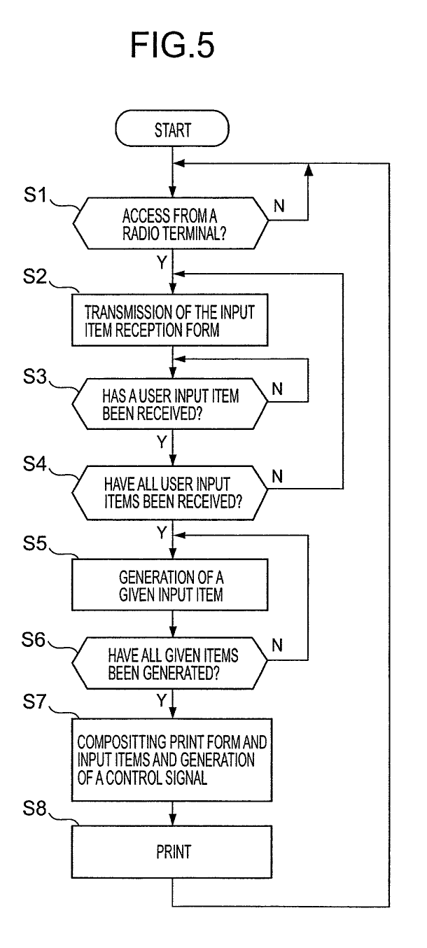

Next, taking an example of a procedure of issuing a membership card in a certain sports club, operation of the printer 10 of the present embodiment will be described. FIG. 5 is a flowchart for explaining the operation of the printer 10 of the present embodiment.

First, when the communication unit 35 is accessed by a radio terminal 25 (S1), the input item reception/generation unit 36 reads the input item reception form data from the input item reception form storing unit 32, and transmits the form data to the radio terminal 25 (hereinafter, referred to as the access terminal) that has accessed the printer 10, through the communication unit 35 (S2). This makes the access terminal to display one of the reception screens as shown in FIG. 3A to FIG. 3C. Then, the input item reception/generation unit 36 awaits transmission of a user input item from the access terminal through the communication unit 35 (S3).

Next, the input item reception/generation unit 36 confirms if all user input items, which specify the private information required for the membership card issuing procedure, are received from the access terminal (S4). When all items are not received, the flow returns to the step S2, where the form data of the screen for receiving a user input item that has not received is transmitted to the access terminal to make the access terminal to display one of the reception screens as shown in FIG. 3A to FIG. 3C. Then, the input item reception/generation unit 36 awaits transmission of the user input item in question (S3).

On the other hand, when all user input items required for specifying the private information required for the membership card issuing procedure are received from the access terminal, then, the input item reception/generation unit 36 automatically generates the given input items if necessary (S5 and S6). Here, as the given input items, a sports club membership period and member's number are generated automatically. The membership period may be determined for example as one year from the date of receiving the user input items, i.e., the present day. Further, the member's number may be determined for example as a unique number obtained by combining a code indicating a course that is received as one of the user input items and a serial number.

Next, the input item reception/generation unit 36 stores the input items (i.e., the user input items and the given input items) obtained by the above processing into the input item storing unit 33. It may be arranged that the input items stored in the input item storing unit 33 can be accessed through the input-output unit 39.

Now, when the storing of the input items into the input item storing unit 33 is finished, the rasterizing/overlay processing unit 41 performs rasterizing processing and overlay processing such that the input items stored in the input item storing unit 33 are arranged on the print form given by the print form data stored in the print form storing unit 31 according to the print condition (a font type, font size, font color, positions on the print form, etc. of the input items) stored in the print condition storing unit 38. RGB image data obtained as a result are converted into CMYK image data by the color conversion/half-tone processing unit 42, and further converted into a control signal by the control signal conversion unit 43, before transmission to the printing mechanism 20 (S7). The printing mechanism 20 performs printing operation according to this control signal (S8).

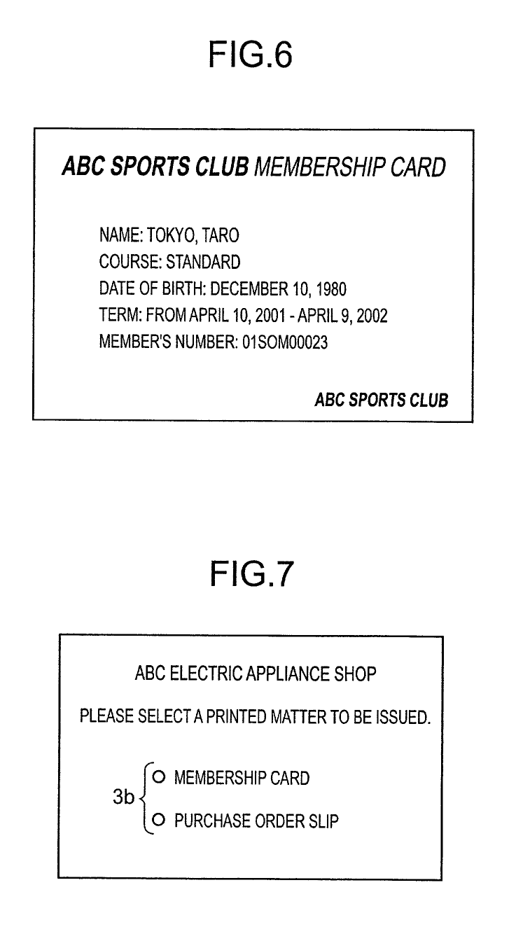

As a result, a membership card as shown in FIG. 6 is printed. In this example, on the print form shown in FIG. 4, are arranged the user input items received through the reception screen as shown in FIG. 3A to FIG. 3B and the given input items generated automatically by the printer 10, according to the print condition stored in the print condition storing unit 38.

Hereinabove, the first embodiment of the present invention has been described.

When a membership card is issued to a user in a membership facility such as a CD rental shop or a sports club, usually a clerk at a reception (window) hands a specific form to the user so that the user enters private information (name, address, etc.) required for issuing a membership card. Then, the clerk receives the form from the user, and inputs the private information entered in the form and other required information such as a member's number etc. into a computer such as a PC functioning as a printer host, to print out a membership card from a printer. Also when an order slip is issued in a CD shop or the like, operation similar to the above is performed. Namely, when a printing system comprising a computer and a printer as its peripheral device is used to provide printing service for issuing a membership card, an order slip, or the like, it requires labor of handing a form to a user so that he enters predetermined items and labor of inputting the input items in the form into the computer.

On the other hand, in the present embodiment, the information required for the membership card issuing procedure is directly transmitted from the radio terminal 25 to the printer 10. Namely, a user who desires issuing of a membership card can print a membership card only by using a radio terminal 25, which is his own or is lent to him by a facility, to input the required information according to instructions from the printer 10 and to transmit the inputted information. Thus, when the printer 10 of the present embodiment is used to provide printing service for issuing a membership card, an order slip, or the like, it is possible to reduce labor of the clerk in comparison with the conventional case.

Here, even the conventional printing system can exclude the interposition of a clerk, by allowing a user to input specific items into a computer. In that case, however, all users must use one computer jointly. Accordingly, usability and service providing efficiency become worse.

Further, in the case where the radio terminal 25 is a portable terminal, such as a PDA (Personal Digital Assistant) for example, owned by a user, then, when the user registers his private information into the radio terminal 25 in advance, input of the private information is not necessary at the time of preparing a membership card. Thus, labor of the user can be reduced also.

The present embodiment has been described taking the example where printed matter outputted from the printer is only a membership card. However, the present invention can be applied to a printer that outputs a plurality of kinds of printed matter. In that case, for each kind of printed matter, input item reception form data, print form data and print condition data are prepared, and these are registered in the input item reception form storing unit 32, the print form storing unit 31 and the print condition storing unit 38, being associated with kinds of printed matter, respectively. Then, previously to the step S2 of FIG. 5, the access terminal is made to display a selection screen as shown in FIG. 7 for selecting a kind of printed matter, so that a user of the access terminal select a kind of printed matter. Then, the input item reception form data, the print form data and the print condition data associated with the selected kind of printed matter are used to perform the processing from S2 onward.

Here, FIG. 7 shows an example of the selection screen for selecting either a membership card issuing procedure or a purchase order slip issuing procedure for “ABC electric appliance shop”. In this example, a selection is received by means of a radio button 3b.

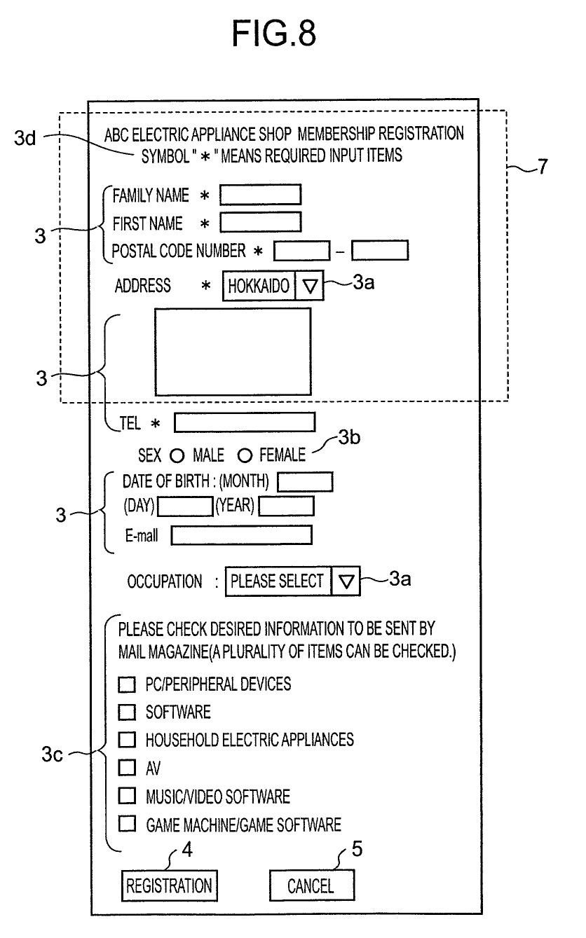

Further, in the present embodiment, the user input items are received from the user of the radio terminal 25 through separate input item reception screens, respectively (FIG. 3A to FIG. 3C, S2 to S4 of FIG. 5). This arrangement is employed considering that a display screen of the radio terminal 25 is small. However, the present invention is not limited to this. For example, it is possible to use one input item reception screen as shown in FIG. 8 through which the user input items are received from the user of the radio terminal 25.

Here, FIG. 8 shows an example of the input item reception screen for receiving the input items required for printing “ABC electric appliance shop membership card”. In addition to input columns 3 for a user to input directly user input items, there are provided a list box 3a, a radio button 3b and a check box 3c for the user to select user input items. Here, the input columns 3 attached with the symbol “*” 301, the list box 3a, the radio button 3b and the check box 3c are required user input items. The other items are optional user input items used for marketing research etc. Further, in FIG. 8, a frame 7 of a dotted line shows a display screen size of the radio terminal 25. As shown in the figure, the input item reception screen is not contained in the frame 7. However, the user can browse the whole input item reception screen by screen scrolling operation.

Now, when the input item reception screen as shown in FIG. 8 is used to receive the user input items from the user of the radio terminal 25, the processing in the steps S2 to S4 shown in FIG. 5 is modified as follows.

Namely, in S2, the input item reception/generation unit 36 reads the input item reception form data from the input item reception form storing unit 32, and transmits the form data to the access terminal through the communication unit 35, to make the access terminal to display the input item reception screen as shown in FIG. 8. Then, in S3, the input item reception/generation unit 36 awaits transmission of the user input items from the access terminal through the communication unit 35. Then, in S4, the input item reception/generation unit 36 confirms if all required user input items are included in the user input items received from the access terminal. When all required user input items are not included, then, the input item reception/generation unit 36 transmits a message to the access terminal to that effect. And, the flow returns to S2 where the access terminal is made to display the input item reception screen again. On the other hand, when all required user input items are included, then, the flow proceeds to S5.

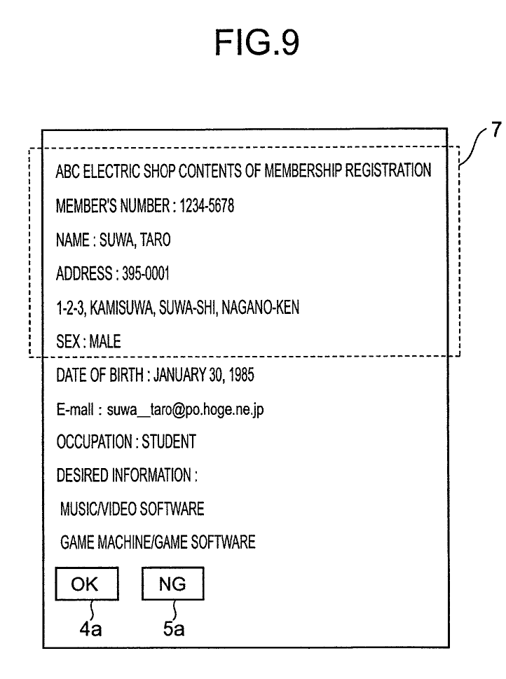

Here, in advance of S5 of FIG. 5, the input item reception/generation unit 36 may make the access terminal display a confirmation screen as shown in FIG. 9 for confirming the user input items received from the access terminal. Then, a confirmation result (i.e., information indicating which of an OK button 4a and an NG button 5a is selected in FIG. 9) from the access terminal. Only when the result is “OK”, the flow proceeds to S5. When the result is “NG”, the flow returns to S2 for receiving the user input items again.

Further, in the present embodiment, the printer 10 is provided with the radio communication circuit 18. However, the radio communication circuit 18 may be provided as a device separate from the printer 10. In that case, the radio communication circuit 18 may be connected with the printer 10 through a wired LAN connected to the interface circuit 16.

Further, the present embodiment has been described taking the example where Bluetooth, infrared communication, or the like is used as the communication line between the radio terminal 25 and the printer 10. However, the present invention is not limited to this. For example, when the radio terminal 25 is a portable telephone, the printer 10 may be provided with an interface with a public network so that the communication between the radio terminal 25 and the printer 10 is realized through the public network. Further, when the radio terminal 25 is an Internet terminal, the printer 10 may be provided with an interface with Internet (World Wide Web) so that the communication between the radio terminal 25 and the printer 10 is realized through Internet.

Further, in the present embodiment, which of a text input box, a list box, a check box and a radio button is used to constitute the input item reception form may be determined depending on a content of the user input item concerned. Here, cryptographic communication may be used to transmit a user input item requiring security, from the access terminal to the printer 10.

Next, a second embodiment of the present invention will be described.

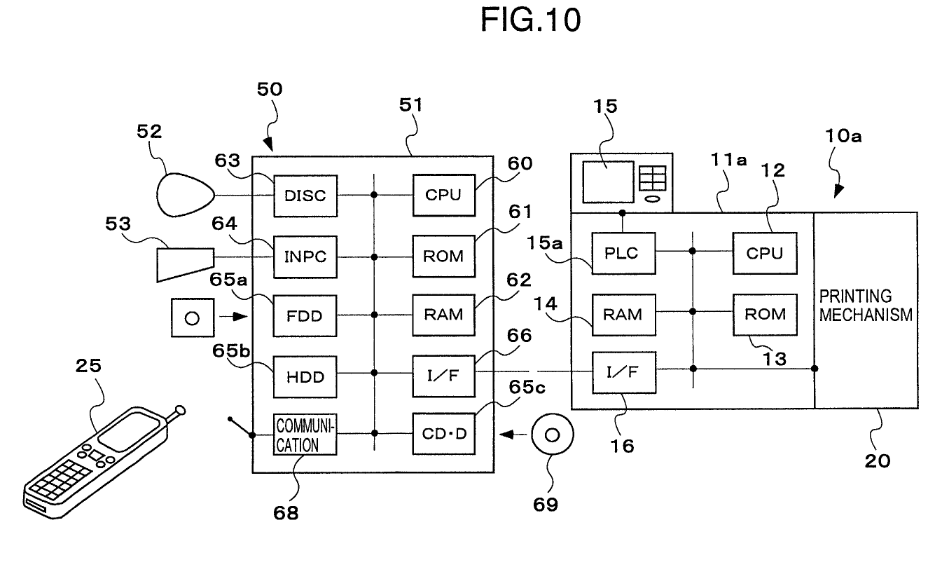

FIG. 10 is a schematic block diagram of a printing system to which the second embodiment of the present invention is applied. The printing system of the present embodiment comprises a printer host 50 and a printer 10a. In the present embodiment, the printer host 50 performs the processing up to the generation of the control signal in the above-described first embodiment.

The printer 10a comprises a printing mechanism 20 and a print control unit 11a. The print control unit 11a has a configuration in which the radio communication circuit 18 and the external storage (FDD 19a and HDD 19b) are omitted in comparison with the print control unit 11 of the printer 10 shown in FIG. 1. This configuration is fundamentally same as an ordinary printer.

As the printer host 50, a computer system such as a PC is used. The printer host 50 comprises a host main unit 51, a display unit 52, an input unit 53 such as a keyboard or a mouse.

The host main unit 51 comprises: a CPU 60; a ROM 61; a RAM 62 functioning as a work area for the CPU 61; a display controller (DISC) 15a for controlling the display unit 52; an input unit controller (INPC) 64 for controlling the input unit 53; external storage such as a floppy (a registered trademark) disk drive (FDD) 65a, a hard disk drive (HDD) 65b, a CD-ROM drive (CDD) 65c and the like; a radio communication circuit 68 for communicating with a radio terminal 25 utilizing, for example, Bluetooth, infrared communication, or the like; and an interface (I/F) circuit 66 for communicating with printer 10.

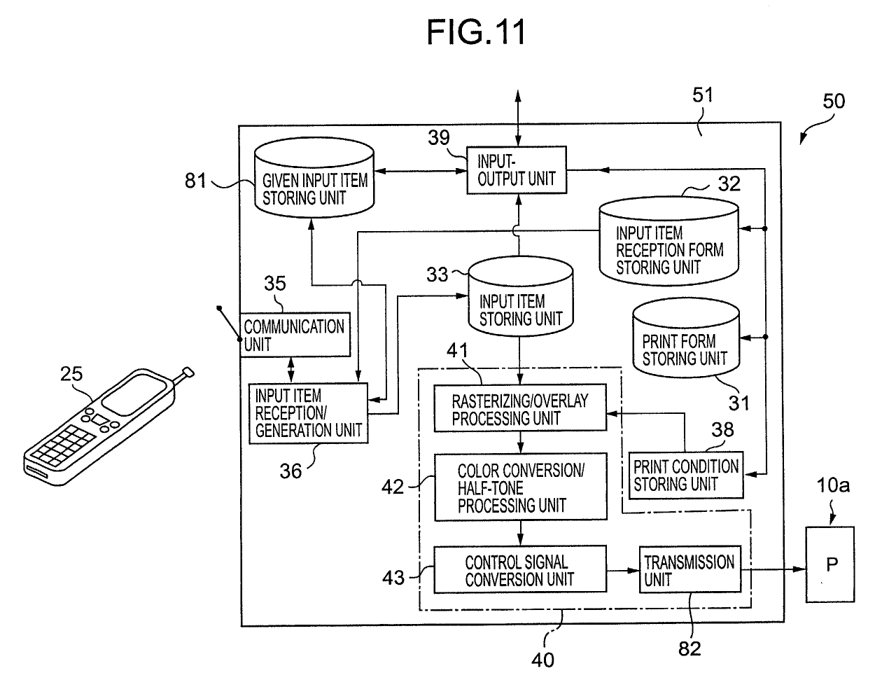

FIG. 11 shows a functional block diagram of the host main unit 51 shown in FIG. 10.

Here, a component having the same function as a component of the printer 10 shown in FIG. 2 is given the same reference numeral. These functional blocks are implemented by the CPU 60 executing programs stored in the external storage such as the ROM 13, HDD 65, or the like. These programs may be obtained from the CD 69 (see FIG. 10) through the CDD 65c, or may be obtained from a communication medium through the radio communication circuit 68 or another network I/F (not shown).

As shown in the figure, the host main unit 51 comprises: a given input item storing unit 81 that stores information required for the input item reception/generation unit 36 to generate the given input items; and a transmission unit 82 for transmitting a control signal generated by the control signal generation unit 42 to the printer 10a; in addition to the components of the print control unit 11 of the printer 10 of the first embodiment shown in FIG. 2.

The present embodiment supposes that the printing system is used for a CD order slip issuing procedure and words card issuing procedure. Accordingly, each of the input item reception form storing unit 32, the print form storing unit 31 and the print condition storing unit 38 stores data for a CD order slip and data for a words card. Further, the given input item storing unit 81 stores a CD list for each genre. Further, the given input item storing unit 81 stores words data for music pieces of each CD, as candidates for the given input items.

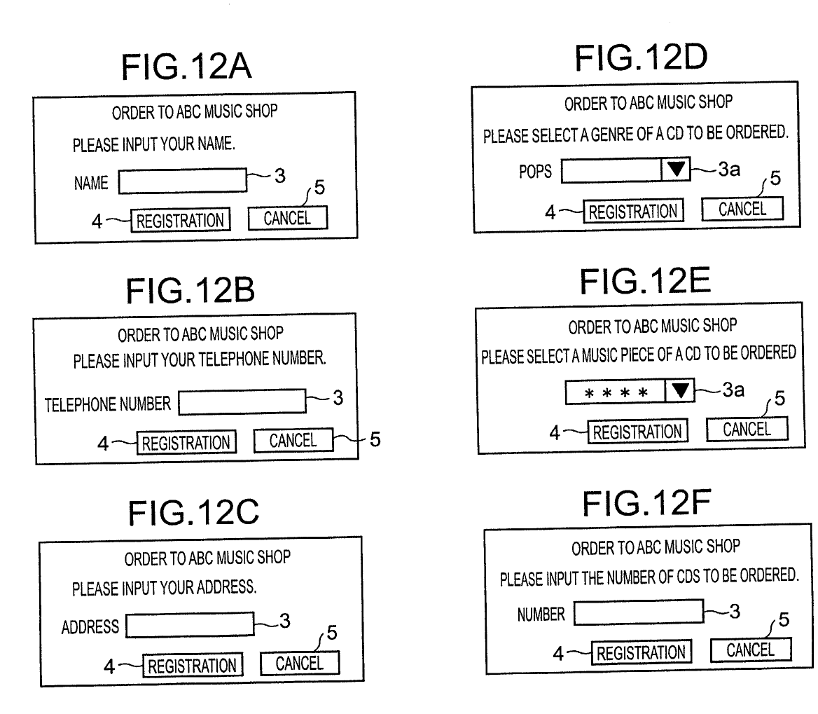

FIG. 12A to FIG. 12F show an example of the input item reception screen displayed on the radio terminal 25 according to the input item reception form data for the CD order slip. Here, input items required for printing “CD order slip of ABC music shop” are received through respective separate screens. In each screen, an input column 3 or a list box 3a is displayed together with an explanation of the user input item concerned. The user of the radio terminal 25 can input information into an input column by key operation for example, or select desired piece of information out of a list.

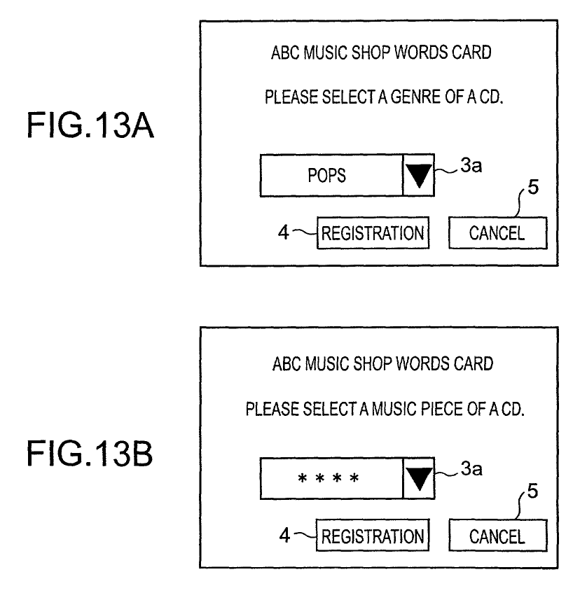

FIG. 13A to FIG. 13B show an example of the input item reception screen displayed on the radio terminal 25 according to the input item reception form data for the words card. Here, input items required for printing a words card are received through respective separate screens. In each screen, a list box 3a is displayed together with an explanation of the user input item concerned. The user of the radio terminal 25 can select a desired piece of information out of a list by key operation for example.

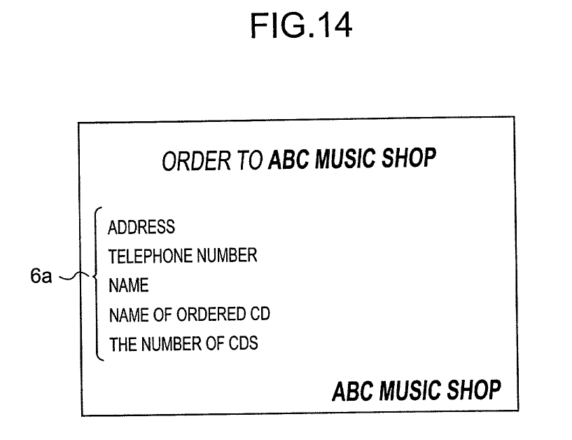

FIG. 14 shows an example of the print form for the CD order slip. Here, the reference numeral 6a refers to explanations of input items printed on the “CD order slip of ABC music shop”, and the input items are overlaid at positions corresponding to the explanations 6a, respectively. Further, the print form for the words card is background data for the words card, and words are overlaid with the corresponding background to obtain a words card.

Hereinabove, the communication unit 35 is implemented by the CPU 60 controlling the radio communication circuit 68. Further, as the various storing units 31 to 33, 81 and the print condition storing unit 38, the external storage such as the FDD 65a or HDD 65b is used. Further, the input-output unit 39 is implemented by the CPU 60 controlling the FDD 65a, CCD 65c, INPC 64, or DSC 63.

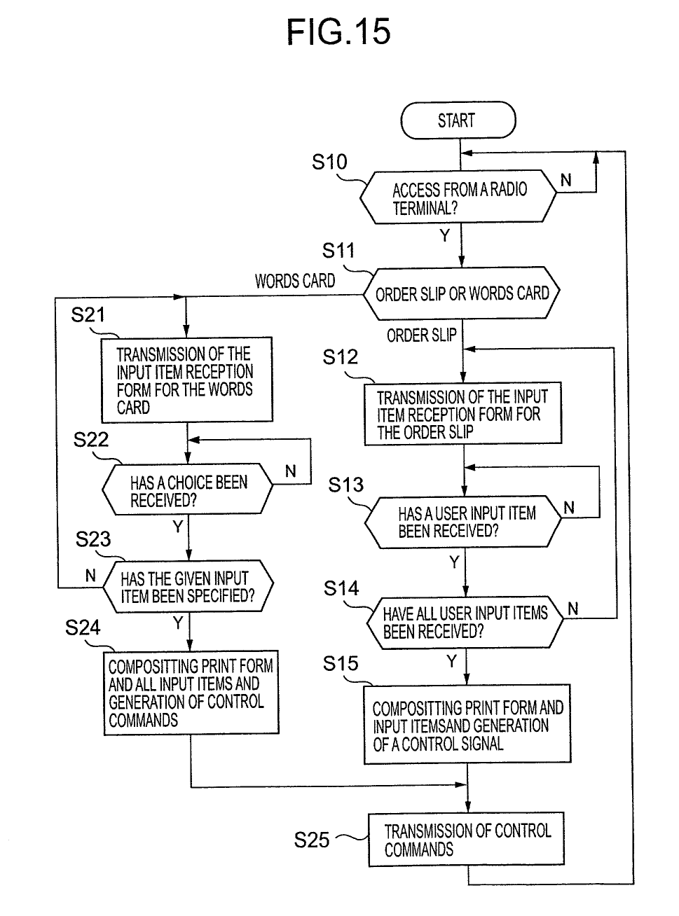

Next, operation of the printer host 50 of the present embodiment will be described taking examples of a CD order slip issuing procedure and a words card issuing procedure in a certain music shop. FIG. 15 is a flowchart for explaining the operation of the printer host 50 of the present embodiment.

First, when the communication unit 35 is accessed by the radio terminal 25 (S10), the input item reception/generation unit 36 reads selective reception form data for allowing selection of either the CD order slip or the words card, from the input item reception form storing unit 32, and transmits the form data to the access terminal through the communication unit 35. This makes the access terminal to display a selection screen for selecting either the CD order slip or the words card. Then, the input item reception/generation unit 36 awaits transmission of a selection result from the access terminal through the communication unit 35.

When the selection result received from the access terminal is the CD order slip (S11), then, the input item reception/generation unit 36 reads the input item reception form data for the CD order slip, from the input item reception form storing unit 32, and transmits the form data to the access terminal through the communication unit 35 (S12). This makes the access terminal to display one of the reception screens as shown in FIG. 12A to FIG. 12F. Then, the input item reception/generation unit 36 awaits transmission of a user input item from the access terminal through the communication unit 35 (S13).

Next, the input item reception/generation unit 36 confirms if all user input items required for ordering a CD are received from the access terminal (S14). If not, then the flow returns to S12, to make the access terminal to display the next reception screen in the order of the reception screens as shown in FIG. 12A to FIG. 12F. Then, the input item reception/generation unit 36 awaits transmission of the user input item concerned (S13).

Here, when the reception screen of FIG. 12E is displayed on the access terminal, the input item reception/generation unit 36 uses the genre received from the access terminal through the screen shown in FIG. 12D to read a CD list that belongs to this genre from the given input item storing unit 81. Then, by incorporating this CD list into the list box 3a, the reception screen shown in FIG. 12E is displayed on the access terminal.

On the other hand, when all user input items required for ordering a CD are received in S14, then, the input item reception/generation unit 36 stores the user input items received in the above processing into the input item storing unit 33.

When the storing of the input items into the input item storing unit 33 is finished, then, the rasterizing/overlay processing unit 41 performs rasterizing processing and overlay processing such that the input items stored in the input item storing unit 33 are arranged on the print form given by the CD order slip print form data stored in the print form storing unit 31 according to the CD order slip print condition stored in the print condition storing unit 38. RGB image data obtained as a result are converted into CMYK image data by the color conversion/half-tone processing unit 42, and further converted into a control signal by the control signal conversion unit 43 (S15). Then, the transmission unit 82 transmits the control signal to the printer 10a (S25).

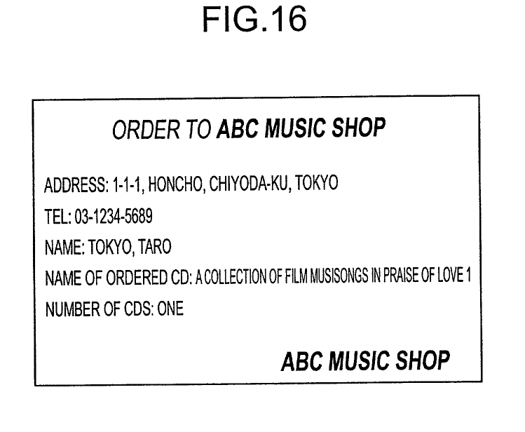

The printer 10a performs printing processing according to the control signal received from the printer host 50. As a result, a CD order slip as shown in FIG. 16 is printed. In this example, the user input items received through the reception screen shown in FIG. 12 are arranged on the print form shown in FIG. 14 according to the CD order slip print condition stored in the print condition storing unit 38.

Now, when, in the step S11, the selection result received from the access terminal is the words card, then, the input item reception/generation unit 36 reads the input item reception form data for the words card from the input item reception form storing unit 32, and transmits the form data to the access terminal. This makes the access terminal display the reception screens as shown in FIG. 13A to FIG. 13B, in order. Then, the input item reception/generation unit 36 awaits transmission of a selection result of each reception screen from the access terminal through the communication unit 35 (S21 to S23).

When the reception screen shown in FIG. 13B is displayed on the access terminal, then, similarly to the case of the screen shown in FIG. 12E, the input item reception/generation unit 36 uses the genre received from the access terminal through the reception screen shown in FIG. 13A displayed on the access terminal previously to this reception screen, to read a CD list that belongs to this genre from the given input item storing unit 81. Then, by incorporating this CD list into the list box 3a, the reception screen shown in FIG. 13B is displayed on the access terminal.

The input item reception/generation unit 36 identifies the music piece of the CD based on the selection result received from the access terminal, and reads the words data of this music piece from the given input items storing unit 81. Then, the words data are stored as the given input item into the input item storing unit 33.

When the storing of the input items into the input item storing unit 33 is finished, then, the rasterizing/overlay processing unit 41 performs rasterizing processing and overlay processing such that the input item (words data) stored in the input item storing unit 33 are arranged on the print form given by the words card print form data stored in the print form storing unit 31 according to the words card print condition stored in the print condition storing unit 38. RGB image data obtained as a result are converted into CMYK image data by the color conversion/half-tone processing unit 42, and further converted into a control signal by the control signal conversion unit 43 (S24). Then, the transmission unit 82 transmits the control signal to the printer 10a (S25). The printer 10a performs printing processing according to the control signal received from the printer host 50. As a result, a words card on which words desired by the user is generated.

Hereinabove, the second embodiment of the present invention has been described.

In the present embodiment, the information required for the CD order slip issuing procedure or the words card issuing procedure is transmitted from the radio terminal 25 to the printer host 50. Accordingly, a clerk of a CD shop does not need to input the information into the printer host 50. Thus, in the case where the printing system of the present embodiment is used to provide printing service for issuing a CD order slip, a words card, or the like, labor of a clerk can be reduced in comparison with the conventional case, when a user uses a radio terminal 25, which is his own or is lent to him by facility, to transmit the input items to the printer host 50, similarly to the first embodiment.

Further, in the case where the radio terminal is a portable terminal such as a PDA (Personal Digital Assistant) for example, owned by a user, then, when the user registers his private information into the radio terminal 25 in advance, input of the private information is not necessary at the time of the issuing procedure. Thus, labor of the user can be reduced also.

The present embodiment has been described taking the example where Bluetooth, infrared communication, or the like is used as the communication line between the radio terminal 25 and the printer host 50. However, the present invention is not limited to this. For example, when the radio terminal 25 is a portable telephone, the printer host 50 may be provided with an interface with a public network so that the communication between the radio terminal 25 and the printer host 50 is realized through the public network. Further, when the radio terminal 25 is an Internet terminal, the communication between the radio terminal 25 and the printer host 50 may be realized through Internet.

Further, which of a text input box, a list box, a check box and a radio button is used to constitute the input item reception form may be determined depending on a content of the user input item concerned. Here, cryptographic communication may be used to transmit a user input item requiring security, from the access terminal to the printer host 50.

Next, a third embodiment of the present invention will be described.

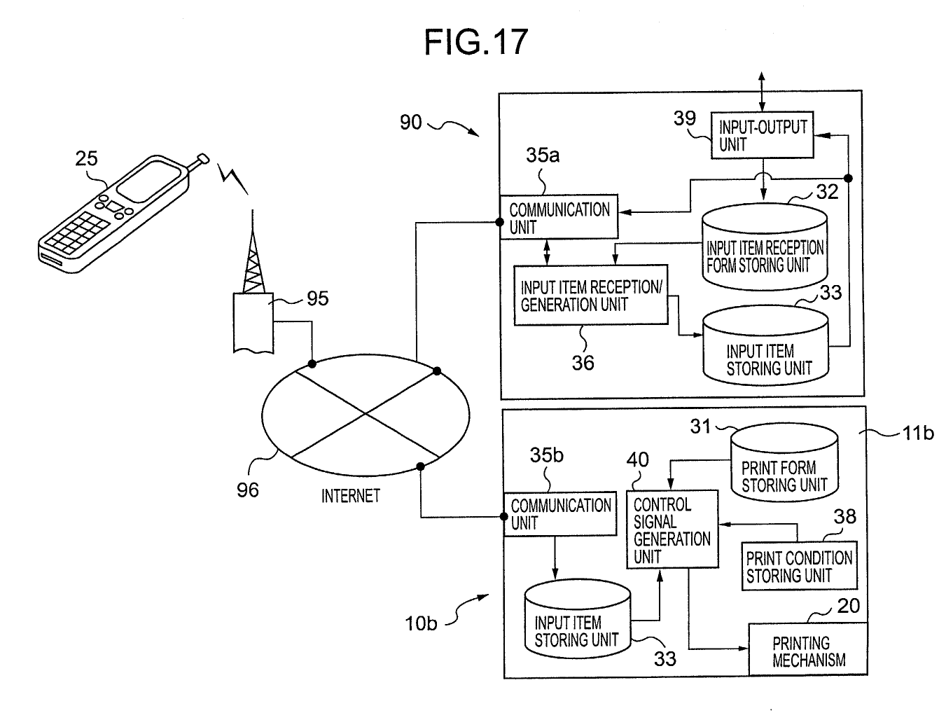

FIG. 17 is a schematic block diagram showing a printing system to which the third embodiment of the present invention is applied. Here, a component having the same function as a component of the printer 10 shown in FIG. 2 is given the same reference numeral. The printing system of the present embodiment comprises an input item reception server 90 and a printer 10b. In the present embodiment, the input item reception server 90 performs the processing up to the processing of obtaining the input items (user input items and given input items) in the above-described first embodiment.

In the present embodiment, the input item reception server 90 has a function of a WWW server, and the radio terminal 25 has a function of a WWW browser terminal. In the example shown in FIG. 17, a radio base station 95 is also an ISP (Internet Service Provider), and thus, the radio terminal 25 is connected to Internet 96 at the radio base station 95. However, when the radio base station 95 is not an ISP, then, the radio terminal 25 may be connected to Internet 96 through an ISP different from the radio base station 95.

The input item reception server 90 is constructed such that, in comparison with the print control unit 11 of the printer 10 of the first embodiment shown in FIG. 2, the print form storing unit 31, the control signal generation unit 40 and the print condition storing unit 38 are omitted from the input item reception server 90, and a communication unit 35a for communicating with the radio terminal 25 or the printer 10b through Internet 96 is provided instead of the communication unit 35. Similarly to the above-described second embodiment, a computer system such as a PC may be used as the input item reception server 90.

The printer 10 comprises a printing mechanism 20 and a print control unit 11b. The printing mechanism 20 is same as one of the printer 10 to which the above-described first embodiment is applied.

The print control unit 11bis constructed such that, in comparison with the print control unit 11 of the printer 10 of the first embodiment shown in FIG. 2, the input item reception form storing unit 32, the input item reception/generation unit 36 and the input-output unit 39 are omitted, and a communication unit 35b for communicating with the input item reception server 90 through Internet 96 is provided instead of the communication unit 35. Hardware configuration of the printer 10b fundamentally same as the printer 10 of the above-described first embodiment.

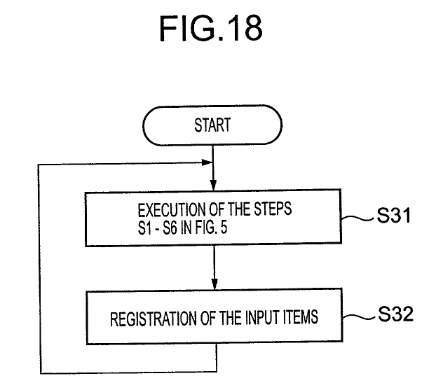

Next, operation of the input item reception server 90 of the present embodiment will be described. FIG. 18 is a flowchart for explaining the operation of the input item reception server 90 of the present embodiment.

First, the input item reception/generation unit 36 performs the steps S1 to S6 in the flow shown in FIG. 5 (S31). Here, the present flow is different from one shown in FIG. 5 in that the radio terminal 25 accesses the input item reception server 90 through Internet. Next, the input item reception/generation unit 36 stores the input items (the user input items and given input items) obtained by the above processing to the input item storing unit 33 provided to the input item reception server 90 (S32).

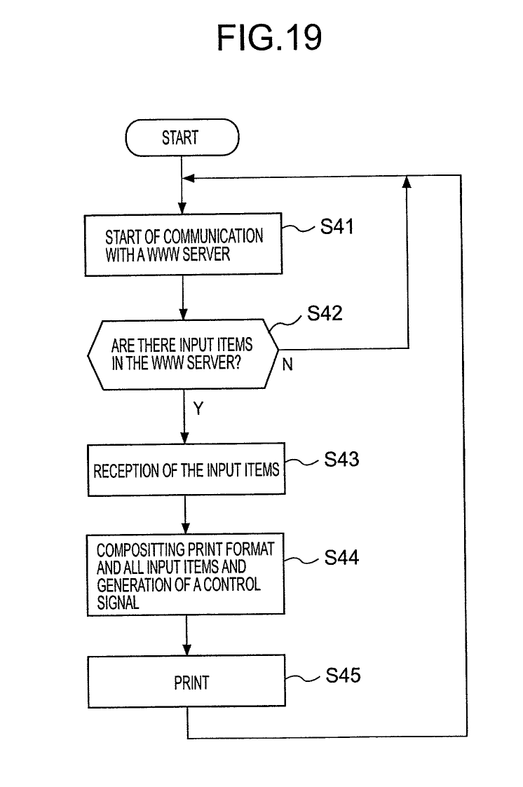

Next, operation of the printer 10b of the present embodiment will be described. FIG. 19 is a flowchart for explaining the operation of the printer 10b of the present embodiment.

First, the communication unit 35b starts communication with the input item reception server 90 (S41). This communication may be started by a trigger of an instruction of an operator, or by a trigger of a predetermined time elapsed. Or, the communication may be triggered by reception of information from the input item reception server 90 to the effect that the input items are received.

Next, the communication unit 35b asks the input item reception server 90 if the input items are stored in the input item storing unit 33 of the input item reception server 90 (S42). When the input items are stored, then, those items are read and received by the communication unit 35b to store them into the input item storing unit 33 of the printer 10b (S43).

When the storing of the input items into the input item storing unit 33 of the printer 10b is finished, then, the control signal generation unit 40 performs rasterizing processing and overlay processing such that the input items stored are arranged on the print form given by the print form data stored in the print form storing unit 31, according to the print condition stored in the print condition storing unit 38. RGB image data obtained as a result is converted into CMYK image data, and further converted into a control signal, to be transmitted to the printing mechanism 20 (S44). The printing mechanism 20 performs printing operation according to this control signal (S45).

Hereinabove, the third embodiment of the present invention has been described.

In the present embodiment, the user input items are transmitted from the radio terminal 25 to the input item reception server 90. Then, the printer 10b obtains the input items from the input item reception server 90 and performs printing based on the input items obtained. Accordingly, in the case where the printing system of the present embodiment is used to provide printing service for issuing a printed matter having a fixed format, labor of a clerk can be reduced in comparison with the conventional case, when a user uses a radio terminal 25, which is his own or is lent to him by a service provider, to transmit the input items to the input item reception server 90, similarly to the first embodiment.

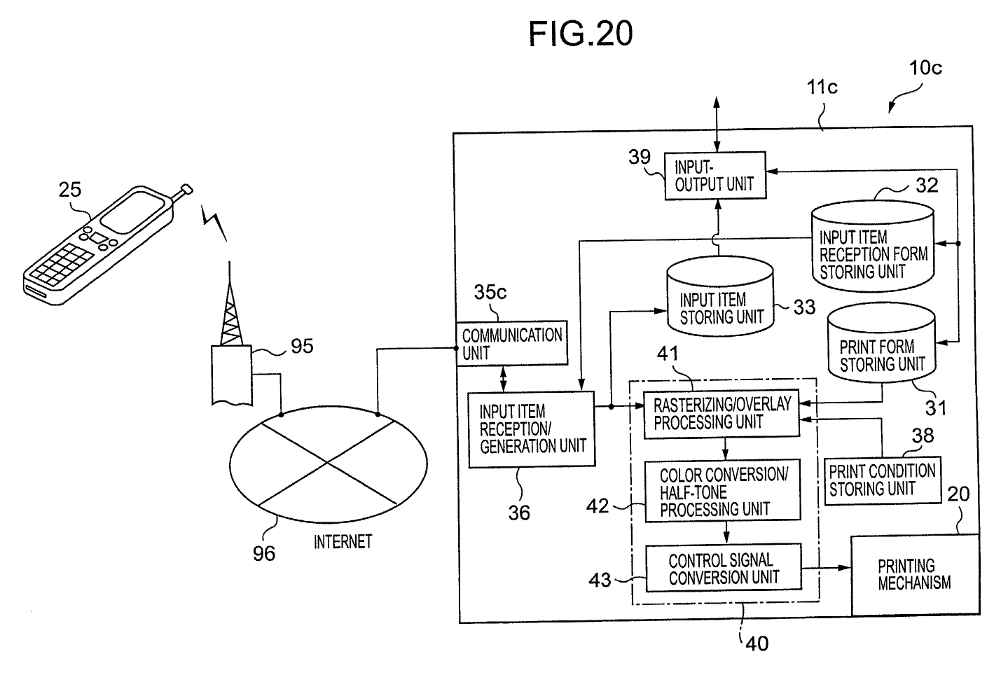

In the present embodiment, the input item reception server 90 performs the processing up to obtaining the input items (the user input items and the given input items). However, the present invention is not limited to this. The printer may be provided with the function of the input item reception server 90, to integrate the printer 10b and the input item reception server 90 in the present embodiment. FIG. 20 shows a variant of the third embodiment of the present invention, and the printer 10c has the function of the input item reception server 90. This configuration is fundamentally same as one where the printer 10 of the first embodiment shown in FIG. 2 is provided with the communication unit 35b for communicating with the radio terminal 25 through Internet 96, instead of the communication unit 35.

Further, in the present embodiment, a printer host is not interposed. However, similarly to the above-described second embodiment, a printer host may be interposed.

As described above, according to the present invention, it is possible to simplify a procedure for preparing a printed matter having a fixed format.

What is claimed is:

1. A printer for printing a printed matter having a fixed format, comprising:
an input item reception form storing means for storing input item reception screen form data for receiving input items from a user of a radio terminal;
a print form storing means for storing print form data, said print form data together with said input items constituting said printed matter;
an input item receiving means for transmitting the input item reception screen form data stored in said input item reception form storing means to the radio terminal, to make said radio terminal display an input item reception screen, and for receiving the input items from the user of said radio terminal through said input item reception screen;
a compositting means for compositting the input items received by said input item receiving means and the print form data stored in said print form storing means; and
a printing means for printing data composite by said compositting means.

2. The printer according to claim 1, wherein:
said printer further comprising a print condition storing means for storing input item print condition data that include at least respective arrangement positions of the input items on a print form; and
said compositting means composites the input items received by said input item receiving means and the print form data stored in said print form storing means, such that said input items are arranged at the respective arrangement positions on the print form, with said arrangement positions being given by the print condition data stored in said print condition storing means.

3. The printer according to claim 1 wherein:
said printer further comprises a print condition storing means for storing input item print condition data that include at least font information; and
said compositting means composites the input items received by said input item receiving means and the print form data stored in said print form storing means, such that the input items are printed by a font indicated by the print condition data stored in said print condition storing means.

4. The printer according to claim 1, wherein:
said input item reception form storing means and said print form storing means respectively store input item reception screen form data and print form data, for each fixed format;
said input item receiving means reads input item reception screen form data corresponding to a fixed format selected by the user of said radio terminal, from said input item reception form storing means, and transmits said input item reception screen form data to said radio terminal; and
said compositting means composites the input items received by said input item receiving means and print form data that is stored in said print form storing means in association with the fixed format selected by the user of said radio terminal.

5. The printer according to claim 1 wherein:
said input item receiving means automatically generates input items (called as “given input items”) to be composite with the print form data, together with the input items (called as “user input items”) received from the user of said radio terminal.

6. A printing system comprising a radio terminal and a printer for printing a printed matter having a fixed format, with said printer having a function of communicating with said radio terminal, wherein:
said printer comprising:
an input item reception form storing means for storing input item reception screen form data for receiving input items from a user of a radio terminal;
a print form storing means for storing print form data, said print form data together with said input items constituting said printed matter;
an input item receiving means for transmitting the input item reception screen form data stored in said input item reception form storing means to the radio terminal, to make said radio terminal display an input item reception screen, and for receiving the input items from the user of said radio terminal through said input item reception screen;
a compositting means for compositting the input items received by said input item receiving means and the print form data stored in said print form storing means; and
a printing means for printing data composite by said compositting means.

7. A printing system comprising a radio terminal, a printer for printing a printed matter having a fixed format and a relay apparatus for relaying communication between said radio terminal and said printer, wherein:
said printer comprises:
an input item reception form storing means for storing input item reception screen form data for receiving input items from a user of a radio terminal;
a print form storing means for storing print form data, said print form data together with said input items constituting said printed matter;
an input item receiving means for transmitting the input item reception screen form data stored in said input item reception form storing means to the radio terminal, to make said radio terminal display an input item reception screen, and for receiving the input items from the user of said radio terminal through said input item reception screen;
a compositting means for compositting the input items received by said input item receiving means and the print form data stored in said print form storing means; and
a printing means for printing data composite by said compositting means.

8. A printing system for printing a printed matter having a fixed format, with said printing system comprising a printer host and a printer, wherein:
said printer host comprises:
an input item reception form storing means for storing input item reception screen form data for receiving input items from a user of a radio terminal;
a print form storing means for storing print form data, said print form data together with said input items constituting said printed matter;
a print condition storing means for storing input item print condition data that include at least respective arrangement positions of the input items on a print form;
an input item receiving means for transmitting the input item reception screen form data stored in said input item reception form storing means to the radio terminal, to make said radio terminal display an input item reception screen, and for receiving the input items from the user of said radio terminal through said input item reception screen;
a compositting means for compositting the input items received by said input item receiving means and the print form data stored in said print form storing means, such that said input items are arranged at the respective arrangement positions on the print form, with said arrangement positions being given by the print condition data stored in said print condition storing means; and
a transmission means for transmitting a print control signal to said printer, with said print control signal being used for printing data composite by said compositting means; and
said printer comprises a printing means for printing the composite data according to the print control signal received from said printer host.

9. The printing system according to claim 8, wherein:
said input item reception form storing means, said print form storing means, and said print condition storing means respectively store input item reception screen form data, print form data, for each fixed format, and input condition data;
said input item receiving means reads input item reception screen form data corresponding to a fixed format selected by the user of said radio terminal, from said input item reception form storing means, and transmits said input item reception screen form data to said radio terminal; and
said compositting means composites the input items received by said input item receiving means and print form data that is stored in said print form storing means in association with said fixed format selected by the user of said radio terminal, such that the input items are arranged at the respective arrangement positions on the print form, with said arrangement positions being given by the print condition data stored in said print condition storing means, in association with the fixed format selected by the user of said radio terminal.

10. A printing system for printing a printed matter having a fixed format, with said printing system comprising an input item reception server and a printer, wherein:
said input item reception server comprises:
an input item reception form storing means for storing input item reception screen form data for receiving input items from a user of a radio terminal; and
an input item receiving means for transmitting the input item reception screen form data stored in said input item reception form storing means to the radio terminal, to make said radio terminal display an input item reception screen, and for receiving the input items from the user of said radio terminal through said input item reception screen; and
said printer comprises:
an obtaining means for obtaining the input items from said input item receiving server, with said input items being received by said input item receiving means from the user of said radio terminal;
a print form storing means for storing print form data, said print form data together with said input items constituting said printed matter;
a print condition storing means for storing input item print condition data that include at least respective arrangement positions of the input items on a print form;
a compositting means for compositting the input items obtained by said obtaining means and the print form data stored in said print form storing means, such that said input items are arranged at the respective arrangement positions on the print form, with said arrangement positions being given by the print condition data stored in said print condition storing means; and
a printing means for printing data composite by said compositting means.

11. The printing system according to claim 10, wherein:
said input item reception form storing means, said print form storing means, and said print condition storing means respectively store input item reception screen form data, print form data, for each fixed format, and input condition data;
said input item receiving means reads input item reception screen form data corresponding to a fixed format selected by the user of said radio terminal, from said input item reception form storing means, and transmits said input item reception screen form data to said radio terminal; and
said compositting means composites the input items received by said input item receiving means and print form data that is stored in said print form storing means in association with said fixed format selected by the user of said radio terminal, such that the input items are arranged at the respective arrangement positions on the print form, with said arrangement positions being given by the print condition data stored in said print condition storing means, in association with the fixed format selected by the user of said radio terminal.

12. A method of printing a printed matter having a fixed format, comprising steps of:
transmitting input item reception screen form data to a radio terminal, to make said radio terminal display an input item reception screen, and receiving input items from a user of said radio terminal through said input item reception screen;
compositting the input items received from the user of said radio terminal and print form data such that said input items are arranged at respective predetermined positions on a print form; and
printing composite data.

13. A program that can be read by a computer, wherein:
when said program is executed by said computer, said program realizes following means on said computer: namely,
an input item reception form storing means for storing input item reception screen form data for receiving input items from a user of a radio terminal;
a print form storing means for storing print form data, said print form data together with said input items constituting said printed matter;
an input item receiving means for transmitting the input item reception screen form data stored in said input item reception form storing means to the radio terminal, to make said radio terminal display an input item reception screen, and for receiving the input items from the user of said radio terminal through said input item reception screen;
a compositting means for compositting the input items received by said input item receiving means and the print form data stored in said print form storing means; and
a transmission means for transmitting a print control signal to a printer connected to said computer, with said print control signal being used for printing data composite by said compositting means.
